(19) United States
(12) Patent Application Publication
(10) Pub. No.: US 2003/0018621 A1
(43) Pub. Date: Jan. 23, 2003

(54) Distributed information search in a networked environment

(76) Inventors: Donald Steiner, Richmond, CA (US); Michael Kolb, Richmond, CA (US)

Correspondence Address: K. Jun Kim, Gray Cary Ware & Freidenrich, 1755 Embarcadero Road, Palo Alto, CA, 94303, US

(21) Appl. No.: 09/895,646

(22) Filed: Jun. 29, 2001

(51) Int. Cl. G06F 7/00

(52) U.S. Cl. 707/3

(57) ABSTRACT

The present invention provides distributed information search mechanisms in a distributed computer network comprising a resource requestor, search brokers, and resource providers. A resource provider may be used to collect and maintain resources, as well as register the resources with a search broker. A search broker may be used to register resource descriptions corresponding to resource providers. A search broker may also maintain the matches between resource descriptions and corresponding resource providers, and find matching resources for search queries. A resource requester may form a search query, receive search results, and present them to a user. When a requester issues a query for an affinity search to the search brokers, they perform the following two steps: identifying the resource providers that can respond to the type of query issued, using the keywords as a guide; and calculating the degree of match (the match quotient) indicating the similarity between the requestor's interest profile and the interest profile of each resource provider that can respond to the query. The search brokers send both the original query and the match quotient to each resource provider who can respond to the query. The resource providers locate the resources that satisfy the query and return the list of the resources directly to the requestor, along with the match quotients. The requestor may rank the results using the match quotient to give higher rankings to web pages that have been viewed by people with similar interests to the requester. Other criteria can also be included in the ranking, including a popularity ranking based on the number of times a URL is returned.

### FIELD OF THE INVENTION

This invention relates generally to a resource search technique in a networked environment. More specifically, the invention relates to an affinity search technique in a peer to peer network architecture.

Conducting a search is a pervasive and ubiquitous activity on networks such as the Internet. A web search on the Internet is more than merely locating web data. It can be a useful tool in a variety of ways. For example, a search can be used to find network resources such as bandwidth, storage and computing capacity. A search can also be used to find specific application programs that exist on the network. For example, when a user needs an e-mail service, text translation service, or file transfer service, the user can search the Internet for the necessary application programs available to the user. A search can also perform more sophisticated data search operations. For example, a search can find relevant information such as location of specific computer users, types of data in a database, and products or services offered by an E-commerce vendor.

In a modern network such as the Internet, the information and resources available on the network are typically vast in amount, and distributed in nature. Thus, the efficiency and cost of a search depend on the architecture of the computer network. Computer networks can be largely classified as using a client-server architecture or a peer-to-peer architecture. In conventional client-server architectures such as used by Yahoo, Alta Vista, or Google, a single computer or a group of computers is dedicated as a central server to serve other computers on the network. When a user sends a search query to the search engine, the dedicated central search engines perform the necessary search on behalf of the user. For example, the central server of Yahoo receives a search query, determines the criteria for finding matching information, finds the resources, and returns the results to the user, without user interruptions.

In a peer-to-peer architecture, the nodes have equivalent responsibilities, and each node can act as both server and client. Using a peer-to-peer architecture, a search can be conducted more thoroughly and efficiently because if any computer in the network has the information being sought, the information can be obtained from the computer without relying on a central server, which may not have the information. Thus, the cost and efficiency of a web search on a peer-to-peer network are improved because recent changes and updates can be incorporated and made available to the users in a more expeditious and less expensive way.

The efficiency and cost of a search in a computer network also depend on the search algorithm and method. Various methods are used to facilitate the search for distributed information on the network. For example, conventional search mechanisms conducted information search based on keywords. In a typical keyword search, the relevance of a document or information is determined by the frequency of the keyword that appears in the document. Documents of higher relevance than a certain threshold value may be selected and returned as a search result.

However, the returned search results in a conventional keyword search may be as accurate or as comprehensive as required. Often, the relevance of a document or information is not proportional to the frequency of a keyword used in the document. For example, a document containing only one reference to a keyword may be far more relevant to a search than a document containing multiple references to the keyword.

In addition, conventional search techniques often require a large amount of resources. Typically, a computer using conventional search techniques must collect, manage, and store the entire database and index all available information. For example, the total amount of information available in the World Wide Web may include Terabytes of data. Indexing and managing such a large volume of data can be prohibitively expensive and resource-intensive. For example, Google currently uses 8,000 PCs to maintain the index and serve search results. At $1,000 per PC, this results in $8,000,000 in hardware cost alone, not taking into account additional software, maintenance, and connection costs.

Further, in order to maintain the search index in a centralized manner, the central server needs to constantly search the web for new and modified web sites. Because the World Wide Web actually changes faster than a central mechanism can keep up with the changes, results returned by conventional techniques are often outdated, inaccurate, and incomplete.

In view of the foregoing, it is highly desirable to provide a search technology that returns more accurate and comprehensive results in a distributed environment. It is also desirable to provide a search technology that improves the efficiency of a search process in a distributed environment without requiring prohibitively large amount of computing resources to maintain the system.

### SUMMARY OF THE INVENTION

The present invention provides distributed information search mechanisms in a distributed computer network comprising a resource requester, search brokers, and resource providers. A resource provider may be used to collect and maintain resources, as well as register information about the resources with a search broker. A search broker may be used to register resource descriptions corresponding to resource providers. A search broker may also maintain the matches between resource descriptions and corresponding resource providers, and find matching resources for search queries. A resource requestor may form a search query, receive search results, and present them to a user.

When a requestor issues a query for an affinity search, the query preferably contains the keywords being searched for. The query is passed to the search brokers, which in turn perform the following two steps: identifying the resource providers that can respond to the type of query issued, using the keywords as a guide; and calculating the degree of match (the match quotient) indicating the similarity between the requestor's interest profile and the interest profile of each resource provider that can respond to the query. In a preferred embodiment, the match quotient is calculated by taking the cosine of their corresponding interest vectors. Because the interest profiles of the requester and the resource providers have been previously registered with the search broker, it has the information necessary to calculate the match quotient.

The search brokers send both the original query and the match quotient to each resource provider who can respond to the query. The resource providers locate the URLs (universal resource locators) that satisfy the query and return the list of the URLs directly to the requester, along with the match quotients.

The requester may rank the results using the match quotient to give higher rankings to web pages that have been viewed by people with similar interests to the requester. Other criteria can also be included in the ranking, including a popularity ranking based on the number of times a URL is returned. A particular URL may be returned by more than one resource providers.

### BRIEF DESCRIPTION OF THE DRAWINGS

FIG. 1 illustrates a network 100 of the type that can be used in conjunction with the invention;

FIG. 2 illustrates a data structure created by a resource provider in accordance with one embodiment of the invention;

FIG. 3 is a flowchart illustrating the process of creating a database for a resource provider in accordance with one embodiment of the invention;

FIG. 4 is a flowchart illustrating a distributed information search process according to one embodiment of the invention; and

FIG. 5 illustrates a data structure created by a search broker in accordance with one embodiment of the invention.

### DETAILED DESCRIPTION OF THE PREFERRED EMBODIMENTS

The invention provides distributed search mechanisms in a networked environment. The invention is particularly applicable to web-based resource searches. It will be appreciated, however, that the invention has greater utility, and is applicable to other types of applications on the Internet or on an intranet such as for search for documents and other information located across the network based on keyword, distributed information organization, and efficient database management. To understand the distributed information search mechanisms in accordance with the invention, the basic architecture of the search mechanism will be described. Then, the application of the distributed information search will be described in conjunction with various types of computer networks.

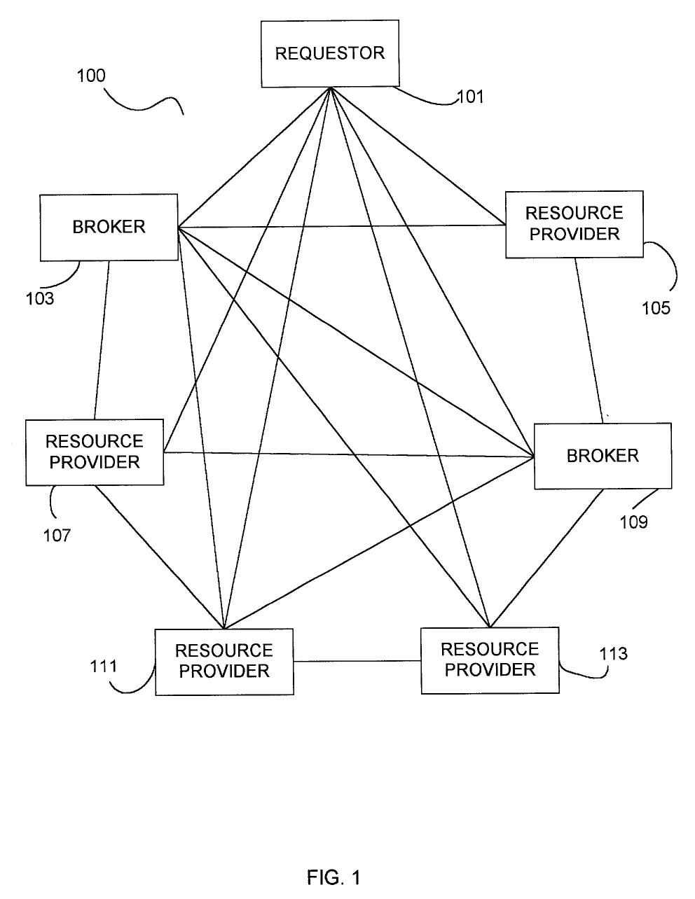

FIG. 1 illustrates a network 100 of the type that can be used in conjunction with the invention. In FIG. 1, seven (7) nodes or computers are shown in the network 100 for illustrative purposes, but more or fewer nodes may be used. Each node 101-113 can be implemented by any suitable computer such as a PC (personal computer) or a workstation or even by another network.

In FIG. 1, a resource requester 101 may be coupled to brokers 103 and 109, and resource providers 105, 107, 111 and 113. The resource requester 101 is a computer that initiates a search query. The broker computers 103 and 109 are provided to register available network resources and coordinate searches on the network 100. The network 100 may be a peer-to-peer, client-server, three-tier, or any other topology. If the network 100 is a client-server network, each node can assume the role of a requester, a search broker, or a resource provider without causing conflict with existing client-server protocols.

Preferably, the nodes 101-113 comprise agents. Preferably, the agents are implemented using software. A software agent comprises a computer program that can accept tasks and perform steps to achieve the tasks without human intervention. A software agent may make decisions and perform various functions based on data stored in a database. In an alternate embodiment, the agents in the network 100 may be implemented using hardware or a combination of software or hardware. If implemented using software, any appropriate computer language may be used to implement the agent. For example, C or Java™ language may be used to implement an agent in software. In FIG. 1, the agents may be used to enable the finding of the various nodes according to their functionality and offered services, as well as the communication and coordination among the nodes.

The search brokers 103 and 109 provide a directory service matching query types to potential resource providers that can respond to this type of query. The registration process includes mechanisms for handling situations where resource providers are temporarily unavailable (e.g. a home PC that has been disconnected from the Internet) or that could connect at different points at different times (e.g. a laptop, personal digital assistant (PDA), or cellular phone).

Each node 101-113 can assume multiple roles, i.e., function as different entities. These include a requester, a resource provider or some other role such as a broker. At any given moment within a search process, however, there is only one requester in the network 100. A resource provider may be used to collect and maintain resources, as well as register the resources with a search broker. A search broker may be used to register resource descriptions corresponding to resource providers. A search broker may also maintain the matches between resource descriptions and corresponding resource providers, and find matching resources for search queries. A resource requester may form a search query, receive search results, and present them to a user.

There can be one or more brokers, and one or more resource providers on the network 100. Also, a given node's role may also change from time to time. For example, a node may generally be a resource provider, except when a user of the node issues a query, in which case the node becomes a requester, and may continue to be a resource provider if the search is to be locally performed.

In operation, a resource requester agent initiates a resource query. In order to enable a distributed search, a requester agent in the network 100 initiates a query by sending a resource query to one or more search brokers. The search brokers are used to facilitate and expedite a search process. Specifically, the search brokers maintain a database of resources made available on the network by corresponding resource providers. Participating resource provider agents catalog and categorize their resources (e.g. information on web sites viewed by their user, or information on their user's PC, or even a search index), preferably by using a document tree, which links the information categories with the source of the information (web URL, document file name, etc.). The resource provider agent may extract the categories from its document tree and register the associated category vectors or interest profiles with one or more search broker(s). Preferably, the search brokers build a tree data structure similar to the individual resource provider agents' trees, linking information categories with resource providers. The information registered with a search broker may be updated on a regular basis to provide more recent information. When a resource query is received, a search broker attempts to find a resource provider matching the resource query. The resource providers are the nodes that have access to various resources. The search broker then forwards the resource query to selected resource providers. When a resource query is received, a resource provider retrieves and sends the requested resource to the requester if there is a matching resource.

In contrast to conventional search systems, the invention can perform a search for distributed information without dedicated central servers by using search brokers. The search brokers of the invention may reduce unnecessary queries and save communication bandwidth by identifying those resource providers who have resources matching a given query. Preferably, the queries are sent only to those matching resource providers.

In order to implement entities such as a requester, a resource provider, and a search broker, the invention provides various data types and functions associated with the entities. Table 1 illustrates data types used for a distributed information search in accordance with a preferred embodiment of the invention. It will be apparent to one skilled in the art that in addition to the data types illustrated in Table 1, other data types and methods may be defined and used as necessary to implement an affinity search.

TABLE 1

| Data Type | Description |
|---|---|
| Resource | A URL of a web page. |
| ResourceDescription | A single hierarchical data structure that represents the interest profile of a |
| | user that is built from the web pages the user is hosting or has previously |
| | visited. |
| ResourceQuery | A list of keywords. |
| AffinityMatch | The match quotient calculated by a search broker. |

In the example shown in Table 1, there are four (4) data types: Resource, ResourceDescription, ResourceQuery, and AffinityMatch. The Resource is data representation used for the search results returned from a resource provider. The ResourceDescription indicates the registration data that a resource provider registers with one or more search brokers. The ResourceQuery is used for the search terms from a requester to a search broker(s), and for the search terms from a search broker(s) to a resource provider(s). The AffinityMatch expresses how closely the interests of a resource provider and the search broker match.

In addition to the specification of data types, associated methods or functions may be used in conjunction with the invention as appropriate. Table 2 illustrates selected methods or functions that can be used in accordance with the invention. It will be apparent, however, to one skilled in the art that these are merely examples, and other suitable methods may be used as well.

TABLE 2

| Role | Method | Arguments | Function |
|---|---|---|---|
| Resource | presentResources( ) | List of Resource | Displays the resources to the |
| Requestor | | | user in a graphical user |
| | | | interface. May also be used |
| | | | in an API. |
| | findResources( ) | ResourceQuery | Returns a list of Resource |
| | findResourceBrokers( ) | none | Returns a list of |
| | | | ResourceBrokers |
| | formSearchQuery | words | Returns an array composed |
| | | | of keywords that the users |
| | | | enter in a text field of search |
| | | | page displayed by the |
| | | | browser. |
| | setTimeOut( ) | Int | Establish a time upon which |
| | | | the search broker presents |
| | | | any collectedResults to the |
| | | | user. |
| | collectResults | URLs, weights | |
| | presentExpertResults( ) | URLs, weights | A form of presentResources, |
| | | | where the resources are |
| | | | identified by URLs and the |
| | | | corresponding weights |
| | | | indicating their relevance to |
| | | | the initial search query. |
| | PresentAffinityResults( ) | URLs, weights, | A special form of |
| | | affinities | presentResources, where the |
| | | | resources are identified by |
| | | | URLs, the corresponding |
| | | | weights indicating their |
| | | | relevance to the initial |
| | | | search query, and the |
| | | | corresponding affinities |
| | | | indicating how well the |
| | | | interests of the source of the |
| | | | URLs (resource providers) |
| | | | match with the interests of |
| | | | the resource requestor. |
| Search Broker | findResourceProviders1( ) | ResourceQuery | Returns the |
| | | | ResourceProviders in the |
| | | | index tree that have one or |
| | | | more of the given words in |
| | | | their corresponding |
| | | | interests. |
| | findResourceProviders2( ) | ResourceQuery | Returns a list of those |
| | | | ResourceProviders in the |
| | | | index tree that have one or |
| | | | more of the given words in |
| | | | their corresponding |
| | | | interests, and whose |
| | | | interests most closely match |
| | | | those of the given Provider. |
| | | | The list is sorted by closest |
| | | | affinity. |
| | registerResourceProvider( ) | ResourceProvider, | Inserts the Resource |
| | | ResourceDescription | Provider and its |
| | | | corresponding interests into |
| | | | the index tree. |
| Resource | getResourceDescription( ) | none | Returns an array composed |
| Provider | | | of, for each top-level |
| | | | wordlist, an array of the n |
| | | | words with the highest |
| | | | weights for that wordlist |
| | | | along with their |
| | | | corresponding weights. n is |
| | | | either pre-determined, or |
| | | | configured by the user. A |
| | | | good value for n is 50. |
| | findResourceBrokers( ) | none | Returns a list of |
| | | | ResourceBrokers |
| | findLocalResources( ) | ResourceQuery | Returns the URLs in the |
| | | | search tree that have one or |
| | | | more of the given words in |
| | | | their corresponding |
| | | | wordlists. |
| | analyzeText( ) | text | Returns a wordlist of all |
| | | | words occurring in the given |
| | | | text along with their |
| | | | corresponding weights. |
| | addURL( ) | URL, wordlist | Inserts the URL and its |
| | | | corresponding wordlist into |
| | | | the search tree. |

In the example shown in Table 2, a resource requester may use methods: presentResources, formSearchQuery, collectResults, presentExperResults, presentAffinityResults, findResourceBrokers, setTimeOut, and findResources. The presentExpertResults method may be used to rank the search results and to make use of them for a search that does not involve affinity. The presentAffinityResults method may be used to rank the search results and to make use of them in a search based on affinity. The findResourceBrokers method may be used to find search broker computers on the network. The formSearchQuery is used to form a query for resources. The collectResultsis used to collect search results returned from resource providers. The findResources may be used to create a list of resources on the network that match the query. The setTimeOut may be used to set a time out period by which a response is expected from a resource provider. After the time out period has expired, the resource requestor may analyze all received responses to the query.

Referring to Table 2, a search broker uses methods: findResourceProviders1, findResourceProviders2, and registerResourceProvider. The findResourceProviders1 may be used to create a list of resource providers who can handle the query, given an input of specific search terms. The findResourceProviders2 may be used to create and sort by affinity a list of resource providers who can handle the query, given an input of specific search terms. The findResourceProviders2 may be implemented by first obtaining a list of resource providers without regard to affinity. The list of resource providers may then be sorted according to their affinities. Preferably, the findResourceProviders2 returns a list of resource providers whose affinity is greater than a predetermined threshold value with respect to the given query. The registerResourceProvider method may be used by each search broker to register a resource provider with the search broker.

A resource provider may use methods: getResourceDescription, findResourceBrokers, findLocalResources, analyzeText, and addURL. The getResourceDescription method may be used to get the description of the resources provided by the resource provider, that is used for the registration of the resource provider with a search broker. The findResourceBrokers method may be used to find search broker computers on the network. The findLocalResources method may be used to conduct a search locally on a resource provider, given an input of specific search terms. The analyzeText may be used to obtain a list of all words in a text along with their corresponding weights.

Using findResourceProviders1 and findResourceProviders2, two different modes of distributed search are enabled. When a distributed web search is desired without involving affinity, the method findResourceProviders1 may be used to find resource providers in the network. If the resource requester requests an affinity search, then the function findResourceProviders2 may be used to find resource providers in the network. A distributed web search without involving affinity is described in greater detail in a U.S. patent application Ser. No. 09/866,224 entitled “Peer-to-Peer Distributed Search Architecture in a Networked Environment,” filed May 24, 2001, which is incorporated herein by reference.

In addition to the methods illustrated in Table 2, requesters, resource providers, and search brokers may use well-known send and receive methods such as TCP/IP, MQSeries, and HTTP in order to send and receive information in the network.

Affinity Search

A goal of an affinity web search is to perform a web search and to rank the resulting URLs in a way that gives a higher ranking to web pages that have been viewed by people with similar interests to the requester.

The matching of the requestor's interests to those of resource providers is enabled by using interest profiles. There are various ways of constructing interest profiles. For example, a profile for an individual might be based on both an analysis of the bookmarks saved by the user and an analysis of all web pages the user has visited. A textual analysis of the web pages that are bookmarked or visited may be performed in order to extract the keywords that best represent the content of the web pages. These keywords are used to construct a hierarchical tree-like data structure that simultaneously represents both the interests of the individual, plus the keywords and URL for each web page they have visited.

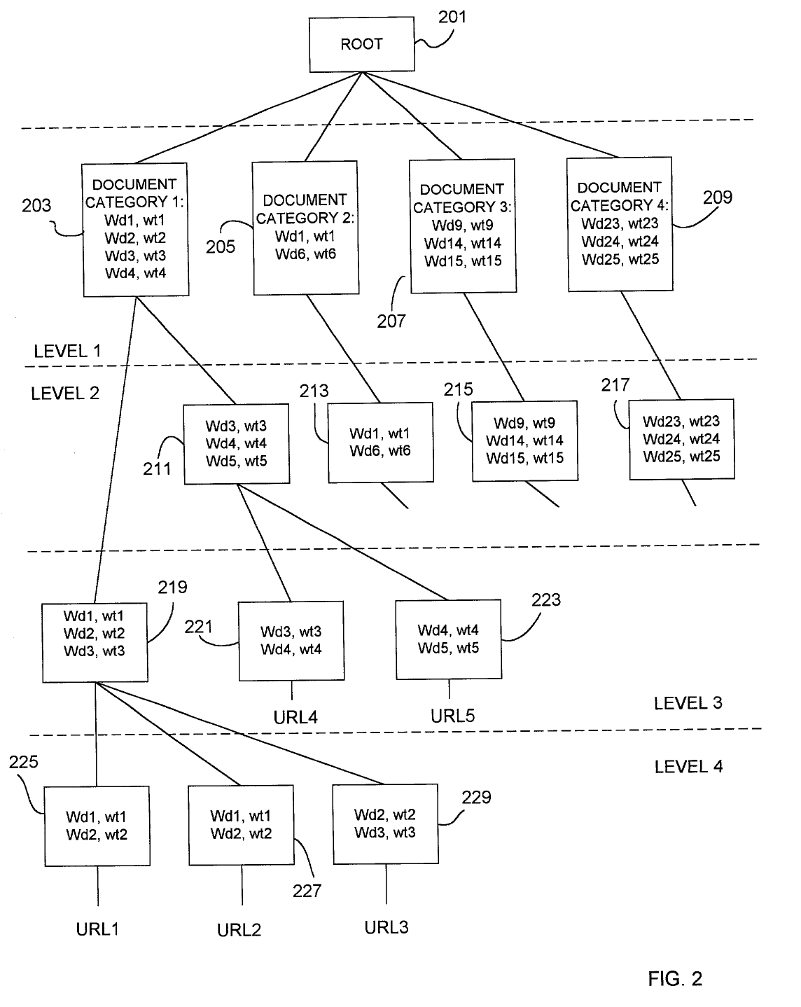

FIG. 2 illustrates a data structure created by a resource provider in accordance with one embodiment of the invention. In a preferred embodiment, the tree shown in FIG. 2 is an n-ary decision tree. In FIG. 2, a root 201 has a plurality of nodes under it divided into multiple levels in a hierarchical manner. In level 1, there are nodes 203, 205, 207, and 209. In level 2, there are nodes 211, 213, 215 and 217. In level 3, there are nodes 219, 221, and 223. In level 4, there are nodes 225, 227 and 229. The root 201 is connected to the nodes 203-209. The node 203 is connected to the nodes 219 and 211, which in turn is connected to the nodes 221 and 223. The node 205 is connected to the node 213, which may be connected to other nodes (not shown). The node 207 is connected to the node 215, which may be connected to other nodes (not shown). The node 209 is connected to the node 217, which may be connected to other nodes (not shown). The node 219 is connected to the nodes 225, 227, and 229.

Although four (4) levels are shown in FIG. 2, it will be apparent to one skilled in the art that there may be more or less than four (4) levels in the tree. The number of levels may be adjusted to accommodate various applications.

Referring to FIG. 2, a node at a higher level in the hierarchy may be connected to any number of nodes in any lower level. However, a node in a lower level may not be connected to more than one node at a higher level. For example, the node 219 in level 3 is connected to nodes 225, 227 and 229 in level 4. However, the node 219 is connected to only one higher level node, node 203, in level 1.

Still referring to FIG. 2, each node except for the root has a wordlist comprising one or more words Wd, and their associated weights (wt). Weights are determined by applying predetermined formulae to words. For example, a weight of a word is calculated by dividing the number of occurrences of the word in a document by the total number of occurrences of all words in the document. Preferably, the weights of the words depend upon which level and which category of the tree they are in. Thus, the weights for a word at a level may be determined by the various weights of the different occurrences of the word in the lower level. For example, Wd1 may occur with different weights in URL1 and URL2, respectively, so that wt1 in node 225 and 227 have different values.

Preferably, the words and their associated weights are represented by a single n-dimensional vector of word/weight pairs. Alternatively, the words may be represented by an n-dimensional vector, and the weights are represented by a separate n-dimensional vector, with the weights occurring in the same position in the weight vector as their corresponding word occurs in the word vector.

The nodes 203, 205, 207 and 209 are used to represent document categories, 1, 2, 3 and 4, respectively. The document category 1 is associated with Wd1 having wt1, Wd2 (wt2), Wd3 (wt3), and Wd4 (wt4), and the document category 2 is associated with Wd1 having wt1 and Wd6 (wt6). The document category 3 is associated with Wd9 having wt9, Wd14 (wt14), and Wd15 (wt15), while the document category 4 is associated with Wd23 having wt23, Wd24 (wt24), and Wd25 (wt25).

The node 211 is associated with Wd3 having wt3, Wd4 (wt4), and Wd5(wt5). The node 213 is associated with Wd1 having wt1 and Wd6 (wt6). The node 215 is associated with Wd9 having wt9, Wd14 (wt14), and Wd15 (wt15), while the node 217 is associated with Wd23 having wt23, Wd24 (wt24), and Wd25 (wt25). The node 219 is associated with Wd1 (wt1), Wd2 (wt2), and Wd3 (wt3). The node 221 is associated with Wd3 (wt3) and Wd4 (wt4) while the node 223 is associated with Wd4 (wt4), Wd5 (wt5). The nodes 225 and 227 are associated with Wd1 (wt1) and Wd2 (wt2) while the node 229 is associated with Wd2 (wt2) and Wd3 (wt3).

The leaves in FIG. 2 are URLs of web pages that may be categorized by the text analyzer. Leaves refer to the end points in the tree shown in FIG. 2 that are not connected to other nodes. For example, URLs 1-5 are considered as leaves. Usually the leaves comprise URLs that have been viewed by the user, but they may be obtained from other sources such as documents or information sources. Each leaf is directly associated with a node comprising a wordlist corresponding to the text of the associated URL. Only the words with the highest n1 weights of each wordlist may constitute the interests, where n1 is a predetermined number. For example, the level 1 wordlists may be considered as the interests of the user. Preferably, the interests are registered, in part, with one or more search brokers.

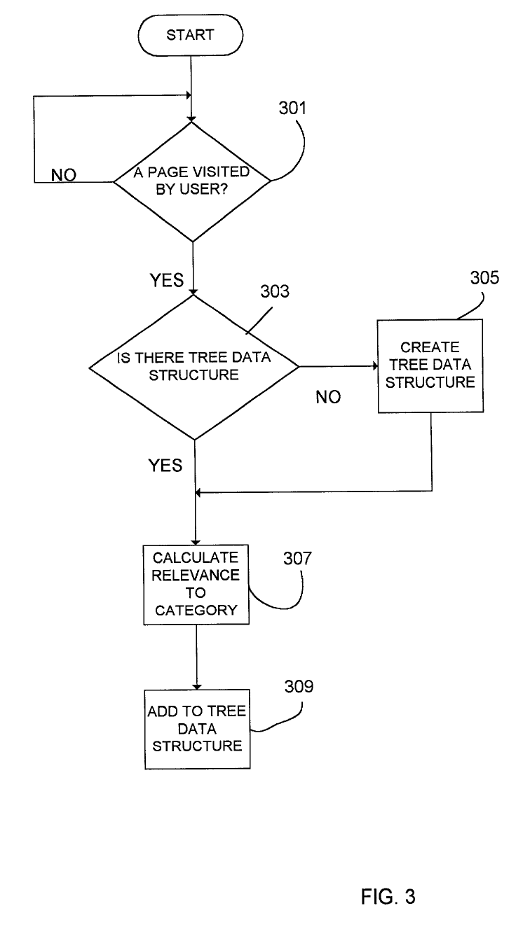

FIG. 3 is a flowchart illustrating the process of creating a database for a resource provider in accordance with one embodiment of the invention. In step 301, the resource provider determines whether a page is visited by a user. If not the resource provider waits until a page is visited. If a page is visited by a user, the resource provider determines whether there is an existing tree data structure in its database in step 303. If so, the resource provider calculates the relevance of the page to various categories in step 307. Otherwise, the resource provider creates a new tree data structure such as shown in FIG. 2 in step 305. The resource provider then adds the page to its tree data structure in step 309.

In order to determine an affinity or relevance of resources or pages in step 307, an agent of a node in the network 100 may analyze every page a user visits through the user's browser. Alternatively, analysis may be limited to certain pages according to certain criteria. The page analysis may result in a set of keyword/weight pairs. Preferably, the agent organizes all of its documents in a tree structure, in which each leaf node in the tree represents a document with its corresponding URL and each inner node of the tree represents a set of related documents (category). How closely two documents or a document and a page/category are related is decided by computing the cosine of the angle between the two vectors representing the documents or categories. For example, a cosine value of 1 may mean a perfect match where as a value of 0 may indicate no relation at all. The root of the tree has no vector associated with it. Each node has a value stored with it, which, depending on its depth in the tree, gives the cosine value a matching document must have as a minimum to be related to the node. This results in a closer relationship between the nodes as a particular branch is traversed further in the tree. Thus, the cosine value of a category means that every document underneath that category matches with any other document in the category by at least that cosine value.

Although a tree data structure is shown in FIG. 3, it will be apparent to one skilled in the art that other data structures may be used in conjunction with the invention. For example, various linked lists may be used instead of or in combination with a tree data structure.

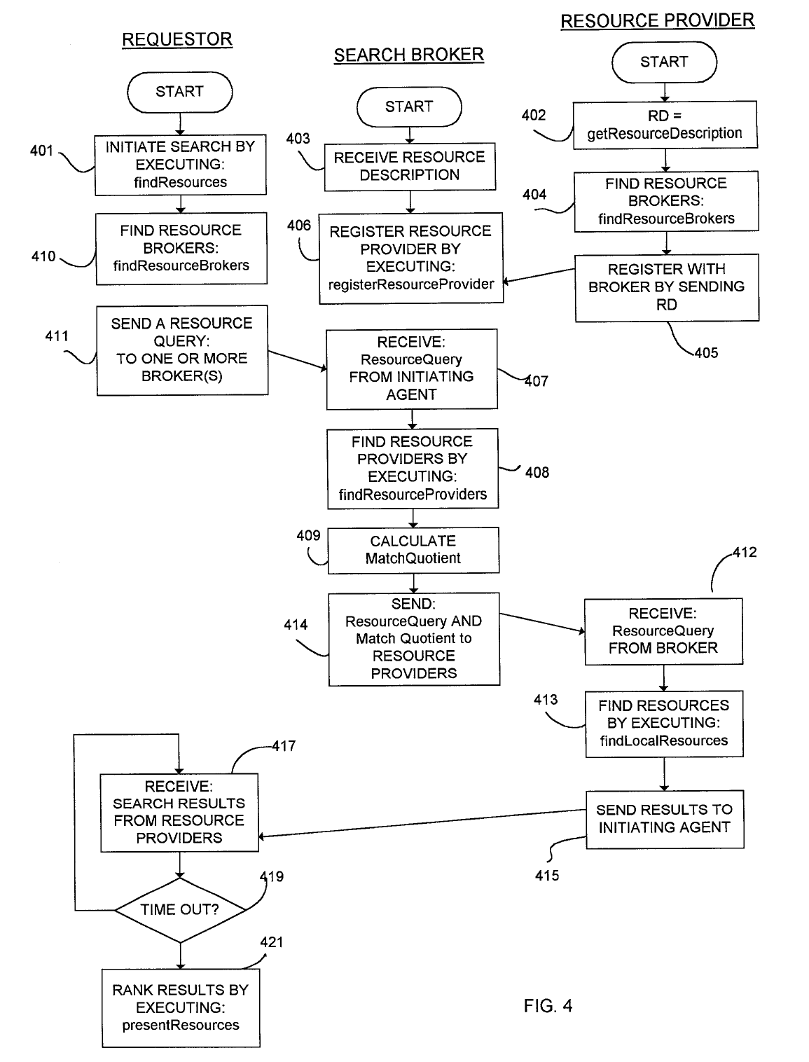

FIG. 4 is a flowchart illustrating a distributed information search process according to one embodiment of the invention. In FIG. 4, there are three (3) participants: a resource requester (initiating agent), one or more search broker(s), and one or more resource provider(s). At any given moment, there is only one requestor in the search process. To enable a distributed web search, each participating resource provider first generates the interest profile for each of its users and registers this profile with one or more search brokers. The registration process is used to provide the search brokers with the information needed to determine candidate resource providers to send a specific query to.

In FIG. 4, a resource provider such as resource provider 105 executes the method getResourceDescription in step 402 in order to get a list of resource descriptions. The resource provider then finds search brokers available on the network in step 404 by executing the method findResourceBrokers. Once search brokers on the network are found, the resource provider registers its resources with one or more search brokers such as broker 203 in step 405 by sending resource descriptions to the search broker(s). The search broker, upon receiving the resource descriptions, executes the method registerResourceProvider in step 406 in order to register the resource provider. The steps 403 and 406 may be executed multiple times in order to register multiple resource providers. The registration information may be periodically updated by the resource providers in order to reflect any changes to pages hosted by the resource provider or new pages visited by users of the resource provider.

Preferably, in order to reduce the amount of data exchanged between a registering agent and the search broker, the agents may compress the data. For compression, the word/weight pairs in the vector are sorted from highest weight to lowest weight. Then, maximal 10% of the words and their weights from the registered category vector, up to a maximum of 50 words, are provided in the resource description. For further compression, each word is transformed into a 4-byte hash code representing the word within the search broker, enabling fast comparison and search in the search broker. In order to facilitate the search, the agents and the search broker use the same hashing algorithm.

A hash algorithm turns messages or text into a fixed string of digits, usually for security or data management purposes. A hash algorithm is a one-way function because it is nearly impossible to derive the original text from the string. Thus, a one-way hash algorithm may be used to create digital signatures and to create indices for table look-up. It is possible that two different words can get mapped onto the same hash value. Using an identical hash algorithm, the same word is assigned to the same hash value on an agent's table or the search broker's table.

Preferably, all the top-level interests of the agents are registered with the search broker. The leaf nodes of the tree on the search broker represent an agent's top-level interests and also contain the identification of the agent that registered the vector. Any inner node represents an interest shared among all the agents underneath the node. Each node has a cosine value assigned to it that indicates how closely the interests underneath the node are related (based on the same vector calculation).

To initiate a resource search, an initiating requester such as the node 101 executes findResources to start the search process in step 401. The resource requester then finds search brokers available on the network in step 410 by executing the method findResourceBrokers. In step 411, the resource requester transmits a resource query to one or more search brokers such as the search brokers 103 and 109. In a preferred embodiment, the requester transforms each query term into a corresponding hash code of the term. Preferably, the resource query also comprises the network address or other communication address (e.g. ID of an agent resident on the requester node) of the resource requestor to allow the recipient of the query to respond directly to the resource requester.

The search broker receives the query in step 407, and finds resource providers by executing findResourceProviders in step 408. In a preferred embodiment, in step 408, the search broker determines candidate resource providers that are most suitable for responding to the query by recursively matching the vector with the nodes of the tree on the search broker. If a node is a leaf node, it represents a resource provider that becomes a candidate for the search. The value of the match (match quotient) indicates how good a candidate a resource provider would be for the given query.

Thus, the search broker determines a match quotient in step 409, and forwards the resource query and the match quotient to those candidate resource providers who can respond to the query in step 414. Preferably, the search broker sorts a list of candidate resource providers from best matches to worst matches. It may then forward the query to the best matching m agents of the candidate list, where m is a predetermined number.

Further, in a highly distributed and dynamic network such as the Internet, some resource providers may not be available to respond to a query from a search broker. In an alternate embodiment of the invention, when a resource provider receives a search query from the search broker, it may send an acknowledgement back to the search broker. Thus, if k of the first m resource providers fail to send an acknowledgement, the search broker forwards the query to the next k resource providers from the candidate list, continuing until a total of m expert agents respond, or until the candidate list is exhausted. In an alternate embodiment of the invention, the search broker may remove the non-responding expert agents from its tree structure, in order to avoid sending queries to them again. When an agent registers its interests with the search broker, the search broker notifies the agent if it had previously been removed from its tree structure. If it had been removed from the search broker's tree, the removed agent re-registers all interests. Otherwise, the agent registers only the changes in its interests with the search broker.

Alternatively, when the search broker cannot find a suitable resource provider or the candidate resource providers are unavailable in step 408, the search broker may initiate a search of its own by forwarding the resource query to other search brokers in order to find candidate resource providers. In this case, the search brokers may be organized in a hierarchical relationship. The steps 407-409 may be repeated multiple times in order to receive and process multiple resource queries.

Still referring to FIG. 4, the selected resource providers receive the resource query in step 412, and execute the method findLocalResources in step 413 to search for the resources that match the keywords. In a preferred embodiment of the invention, each resource provider receiving the query from the search broker transforms the query terms into a vector according to its dictionary and recursively matches that vector against the tree of documents on the search broker. The matching documents range from the best matching to the worst. However, in an alternate embodiment of the invention, some resource providers may decide to ignore the resource query or delay responding to it. The search in step 413 may include the web pages that the resource provider hosts, as well as the web pages that the resource provider's users have visited. In one embodiment of the invention, the search is performed using a pre-computed index generated at the time the responding resource provider calculated the keywords for the page.

Typically the method findLocalResources returns the resources on the local machine or the computer that is performing the method findLocalResources. Resources can also be found by the local computer launching a separate query of its own to find additional resources. Thus, the resource providers responding to a query may launch another resource query of their own to find resources on other computers.

The resource providers deliver the search results directly to the original requestor in step 415. Optionally, the resource providers may deliver the search results to the search broker in order to allow caching of the information or for other reasons. By using cached information, the search broker can respond to the same query more quickly without having to communicate the query to resource providers. The steps 412, 413 and 415 may be repeated multiple times in order to receive and process multiple resource queries.

The original resource requestor receives the output (search results) of the responding resource provider in step 417, and determines whether a time period to await the search results has expired in step 419. The original requester may use a variable CollectedResults to collect the search results returned from the resource providers. If the time period has expired in step 419, then the requestor stops accepting any new search results, and may optionally execute presentResources in step 421 to rank and present the received search results. If the time period has not expired in step 419, the requestor continues to step 417, and waits to receive additional search results from other resource providers.

Referring to FIG. 4, it is possible that the resource requester is also a resource provider who previously registered with the search broker. If so, the search broker has information as to the interests of the resource requester because the requestor has registered its interests. In this case, the search broker may further tailor the search to fit the interests of the requestor. For example, the affinity of the resource requestor and other resource providers may be calculated by determining the cosine values of the vectors representing the requester and other resource providers. The search broker may then select as candidate resource providers those that have an affinity higher than a certain predetermined value.

Thus, in contrast to conventional search systems, the search results returned by the invention may be tailored to individual requesters. For example, when a search may be performed based on affinity of a user (requester), the returned search results will rank and present the search results according to the affinity of the user. Even if it is a query for the same keyword “palm,” the returned search results may vastly differ depending on the affinity of the requestor. If the requestor's registered interests are in electronics or computer equipment, the query will be sent to those resource providers that have information on computer devices, hand held devices, or cellular phones. However, if the requestor's registered interests indicate that it is interested in botany, the query will be sent to those resource providers that have information on palm trees, coconut palms, and tropical plants, and returned search results will reflect the requestor's interests.

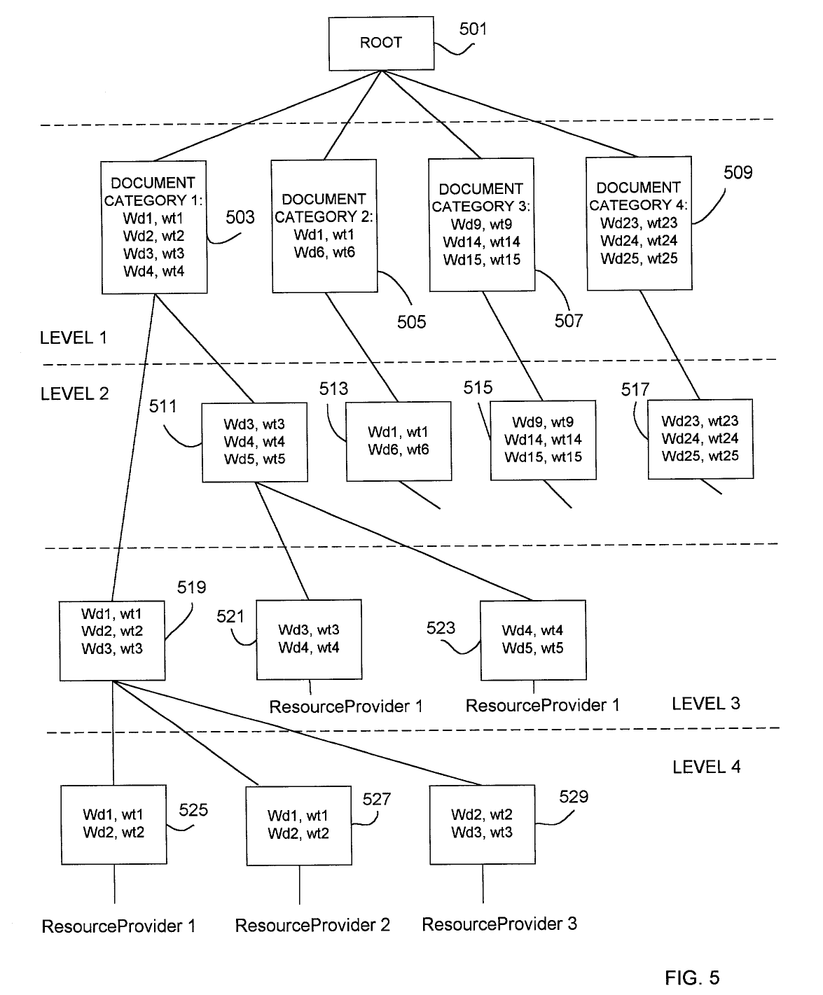

As illustrated in FIG. 4, a search broker registers resource providers in step 406. To facilitate database maintenance and enable an efficient search, the search broker preferably constructs a database similar to a tree data structure shown in FIG. 2. FIG. 5 illustrates a data structure created by a search broker in accordance with one embodiment of the invention. In contrast to the data structure shown in FIG. 2, the leaves in FIG. 5 are resource providers that have been categorized by the text analyzer.

In FIG. 5, a root 501 has a plurality of nodes under it divided into multiple levels in a hierarchical manner. In level 1, there are nodes 503, 505, 507, and 509. In level 2, there are nodes 511, 513, 515 and 517. In level 3, there are nodes 519, 521, and 523. In level 4, there are nodes 525, 527 and 529. The root 501 is connected to the nodes 503-509. The node 503 is connected to the nodes 519 and 511, which in turn is connected to the nodes 521 and 523. The node 505 is connected to the node 513, which may be connected to other nodes (not shown). The node 507 is connected to the node 515, which may be connected to other nodes (not shown). The node 509 is connected to the node 517, which may be connected to other nodes (not shown). The node 519 is connected to the nodes 525, 527, and 529.

Referring to FIG. 5, a node at a higher level in the hierarchy may be connected to any number of nodes in any lower level. However, a node in a lower level may not be connected to more than one node at a higher level. For example, the node 519 in level 3 is connected to a nodes 525, 527 and 529 in level 4. However, the node 519 is connected to only one higher level node, node 503, in level 1.

Still referring to FIG. 5, each node except for the root has a wordlist comprising one or more words Wd, and their associated weights (wt). Preferably, the associated weights are represented by an n-dimensional vector. The nodes 503, 505, 507 and 509 are used to represent document categories, 1, 2, 3 and 4, respectively. The document category 1 is associated with Wd1 having wt1, Wd2 (wt2), Wd3 (wt3), and Wd4 (wt3), and the document category 2 is associated with Wd1 having wt1 and Wd6 (wt6). The document category 3 is associated with Wd9 having wt9, Wd14 (wt14), and Wd15 (wt15), while the document category 4 is associated with Wd23 having wt23, Wd24 (wt24), and Wd25 (wt25).

The node 511 is associated with Wd3 having wt3, Wd4 (wt4), and Wd5(wt5). The node 513 is associated with Wd1 having wt1 and Wd6 (wt6). The node 515 is associated with Wd9 having wt9, Wd14 (wt14), and Wd15 (wt15), while the node 517 is associated with Wd23 having wt23, Wd24 (wt24), and Wd25 (wt25). The node 519 is associated with Wd1 (wt1), Wd2 (wt2), and Wd3 (wt3). The node 521 is associated with Wd3 (wt3) and Wd4 (wt4) while the node 523 is associated with Wd4 (wt4), Wd5 (wt5). The nodes 525 and 527 are associated with Wd1 (wt1) and Wd2 (wt2) while the node 529 is associated with Wd2 (wt2) and Wd3 (wt3).

Generally, any requestor may also be a resource provider if the requestor computer also has capability to function as a resource provider. Thus, a resource requestor may register its interest profile with a search broker. If a requestor does not have a resource provider capability, the requestor may calculate an interest profile for its users that want to issue queries and register these with a search broker, prior to performing any searches.

The above discussion, examples and embodiments illustrate our current understanding of the invention. However, since many variations of the invention can be made without departing from the spirit and scope of the invention, the invention resides wholly in the claims hereafter appended.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer program product for use in conjunction with a network comprising a resource requester, at least one search broker and at least one resource provider, the computer program product comprising a computer readable storage medium and a computer program mechanism embedded therein, the computer program product comprising:
first instructions for sending a resource query executable by said resource requester;
second instructions executable by said search broker for registering a weight vector of said resource provider;
third instructions executable by said search broker for finding said resource provider matching said resource query by comparing said weight vector of said resource provider and said query;
fourth instructions executable by said search broker for sending said resource query to said resource provider; and
fifth instructions executable by said resource provider for finding resources available matching said resource query.

2. A computer program product for use in conjunction with a network comprising a resource requestor, at least one search broker and at least one resource provider, the computer program product comprising a computer readable storage medium and a computer program mechanism embedded therein, the computer program product comprising:
first instructions executable by said search broker for registering said resource requester and a requestor weight vector with said resource broker;
second instructions executable by said search broker for registering said resource provider and a resource provider weight vector;
third instructions executable by said resource requestor for sending a resource query to said resource broker;
fourth instructions executable by said search broker for determining an affinity of said resource provider based on said requester weight vector and said resource provider weight vector;
fifth instructions executable by said search broker for sending said resource query to said resource provider; and
sixth instructions executable by said resource provider for finding resources matching said resource query.

3. The computer program product of claim 2, wherein query comprises a keyword and a weight associated with said keyword.
